(19) United States
(12) Patent Application Publication
(10) Pub. No.: US 2024/0080330 A1
(43) Pub. Date: Mar. 7, 2024

(54) SECURITY MONITORING APPARATUS, SECURITY MONITORING METHOD, AND COMPUTER READABLE MEDIUM

(71) Applicant: Mitsubishi Electric Corporation, Tokyo (JP)

(72) Inventors: Aiko IWASAKI, Tokyo (JP); Takumi YAMAMOTO, Tokyo (JP); Hajime KOBAYASHI, Tokyo (JP); Kiyoto KAWAUCHI, Tokyo (JP)

(73) Assignee: Mitsubishi Electric Corporation, Tokyo (JP)

(21) Appl. No.: 18/384,926

(22) Filed: Oct. 30, 2023

Related U.S. Application Data
(63) Continuation of application No. PCT/JP2021/023249, filed on Jun. 18, 2021.

(51) Int. Cl. H04L 9/40; H04L 41/16

(52) U.S. Cl. CPC H04L 63/1425; H04L 41/16; H04L 63/1416

(57) ABSTRACT

A security monitoring apparatus (100) includes a content category deducing unit (122), a category comparing unit (123), and an information assignment unit (130). The content category deducing unit (122) deduces a first deduced category that is a result of deducing a category of content that a target device that a monitoring target system (200) includes has, using a content category deducing model that is a learning model that deduces using content data that indicates content, a category of content indicated in the content data, and data that indicates content that the target device has. The category comparing unit (123) verifies whether or not the first deduced category and a category for comparison match. The information assignment unit (130) generates assignment information that is in accordance with whether or not the first deduced category and the category for comparison match.

### CROSS REFERENCE TO RELATED APPLICATIONS

This application is a Continuation of PCT International Application No. PCT/JP2021/023249, filed on Jun. 18, 2021, which is hereby expressly incorporated by reference into the present application.

### TECHNICAL FIELD

The present disclosure relates to a security monitoring apparatus, a security monitoring method, and a security monitoring program.

### BACKGROUND ART

There is technology to detect an anomaly in data by creating a rule, an inference model, or the like using data in a normal state and verifying whether or not the data deviated from the normal state using the rule, the model, or the like created. Since an activity different from normalcy in communication can be discovered using the present technology, making use of the present technology to detect malicious activity such as a cyberattack is expected.

Patent Literature 1 discloses technology to classify an URL (Uniform Resource Locator) by granularity that is coarse such as a domain, a category level, or the like, verify an anomaly that relates to communication using a rule that is in accordance with a result of the classified, and present a verification result and information that relates to a cause of the anomaly to an administrator.

### CITATION LIST

### Patent Literature

Patent Literature 1: WO 2016/031034 A1

### SUMMARY OF INVENTION

### Technical Problem

Since the technology that Patent Literature 1 discloses does not automatically find a change from the past in a category of content that a communication destination has, there is an issue where it necessitates an administrator of a system to investigate whether or not a category of content that a transmission destination has changed from the past even in a case where the change from the past in the category of the content that the communication destination has is the cause of the anomaly that relates to the communication.

The present disclosure aims to automatically find a change from the past in a category of content that a communication destination has and present a result of what is found to an operator and the like of a system.

### Solution to Problem

A security monitoring apparatus according to the present disclosure includes:

a content category deducing unit to deduce a first deduced category that is a result of deducing a category of content that a target device that a monitoring target system includes has, using a content category deducing model that is a learning model that deduces using content data that indicates content, a category of content indicated in the content data, and data that indicates content that the target device has;

a category comparing unit to verify whether or not the first deduced category and a category for comparison match; and

an information assignment unit to generate assignment information that is in accordance with whether or not the first deduced category and the category for comparison match.

### Advantageous Effects of Invention

According to the present disclosure, a content category deducing unit deduces a category of content that a target device has, a category comparing unit verifies whether or not the category deduced matches a category for comparison, and an information assignment unit generates assignment information that is in accordance with a result of the verified. The target device may be a communication destination, the category for comparison may be a category of content that the target device had in the past, and the assignment information may be assigned to information that notifies an operator and the like of a system of a communication anomaly. Consequently, according to the present disclosure, in a case where there is a change from the past in a category of content that the communication destination has, the change from the past in the category of the content that the communication destination has is automatically found and a result of the found can be presented to the operator and the like of the system.

### BRIEF DESCRIPTION OF DRAWINGS

FIG. 1 is a diagram illustrating an example of a configuration of a security monitoring system 90 according to Embodiment 1.

FIG. 2 is a diagram illustrating a specific example of a communication log according to Embodiment 1.

FIG. 3 is a diagram illustrating an example of a hardware configuration of a security monitoring apparatus 100 according to Embodiment 1.

FIG. 4 is a flowchart illustrating operation of the security monitoring apparatus 100 according to Embodiment 1 at a time of learning.

FIG. 5 is a flowchart illustrating operation of the security monitoring apparatus 100 according to Embodiment 1 at a time of detection.

FIG. 6 is a diagram illustrating assignment information that an information assignment unit 130 according to Embodiment 1 assigns.

FIG. 7 is a diagram illustrating an example of a hardware configuration of a security monitoring apparatus 100 according to a variation of Embodiment 1.

FIG. 8 is a diagram illustrating an example of a configuration of a security monitoring system 90 according to Embodiment 2.

FIG. 9 is a flowchart illustrating operation of a security monitoring apparatus 100 according to Embodiment 2 at a time of learning.

FIG. 10 is a flowchart illustrating operation of the security monitoring apparatus 100 according to Embodiment 2 at a time of detection.

FIG. 11 is a diagram illustrating an example of a configuration of a security monitoring system 90 according to Embodiment 3.

FIG. 12 is a diagram illustrating assignment information that an information assignment unit 130 according to Embodiment 3 assigns.

FIG. 13 is a diagram illustrating an example of a configuration of a security monitoring system 90 according to Embodiment 4.

### DESCRIPTION OF EMBODIMENTS

In the description of the embodiments and in the drawings, the same reference signs are added to the same elements and corresponding elements. Descriptions of elements having the same reference signs added will be suitably omitted or simplified. Arrows in the diagrams mainly indicate flows of data or flows of processes. “Unit” may be suitably replaced with “circuit”, “step”, “procedure”, “process”, or “circuitry”.

### Embodiment 1

The present embodiment will be described in detail below by referring to the drawings.

The present embodiment is based on an assumption that a category of content of a communication destination basically does not change at normal times, but changes in a case where the category of the content of the communication destination is tampered with and the like by an attacker.

Description of Configuration

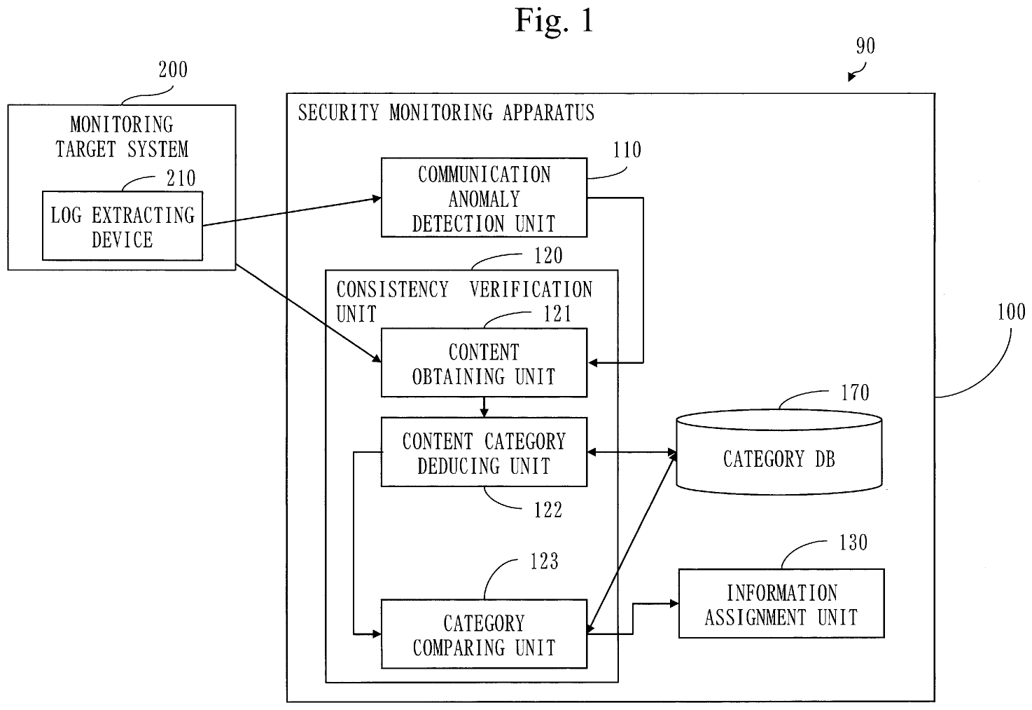

FIG. 1 illustrates an example of a configuration of a security monitoring system 90 according to the present embodiment. The security monitoring system 90 includes a security monitoring apparatus 100 and a monitoring target system 200 as illustrated in the present diagram. A plurality of each of the security monitoring apparatus 100 and the monitoring target system 200 may exist. The security monitoring apparatus 100 and the monitoring target system 200 may be suitably configured integrally.

The security monitoring apparatus 100 is an apparatus that monitors the monitoring target system 200, and includes a communication anomaly detection unit 110, a consistency verification unit 120, an information assignment unit 130, and a category DB (Database) 170. The security monitoring apparatus 100 suitably outputs an alert in a case where an anomaly in a communication log of the monitoring target system 200 is detected.

The communication anomaly detection unit 110 learns, using the communication log of the monitoring target system 200, a normal communication deducing model that is a learning model that deduces, using a communication log of a content device that is a device having content, whether or not the communication log of the content device is an anomaly, and deduces, using the normal communication deducing model learned and a communication log of a target device, whether or not the communication log of the target device is normal. Here, the communication log of the monitoring target system 200 indicates a transmission and reception record of a device and the like that the monitoring target system 200 includes. The transmission and reception record, as a specific example, is a record of a terminal that the monitoring target system 200 includes accessing a server that the monitoring target system 200 includes. The normal communication deducing model is a model that deduces with the communication log as input, whether or not the communication log inputted is normal. The target device is a server and the like that the monitoring target system 200 includes. The communication anomaly detection unit 110 generates an alert in a case where an anomaly in the communication log inputted is deduced by the normal communication deducing model. The communication anomaly detection unit 110 does not have to learn the normal communication deducing model and may use a normal communication deducing model that a different device and the like generated. A configuration of the communication anomaly detection unit 110 may be in a configuration that includes a normalcy learning unit and an anomaly verification unit. The communication anomaly detection unit 110 may use any existing technology when generating the normal communication deducing model. The normal communication deducing model is a learning model that learned a relationship between the communication log and a state of the communication log that indicates whether the communication log is normal or abnormal, and may be an inference model based on machine learning, or may be a program and the like that adopts a system that is based on a rule such as a rule-based system and the like.

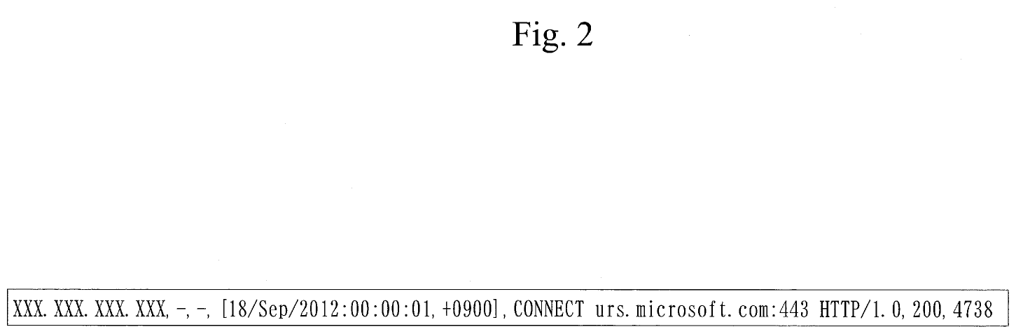

FIG. 2 illustrates a specific example of the communication log. The communication log consists of information on an IP (Internet Protocol) address of the communication destination, a communication date and time, and the like.

The consistency verification unit 120 includes a content obtaining unit 121, a content category deducing unit 122, and a category comparing unit 123.

The content obtaining unit 121 obtains the content that the communication destination has based on information on the communication destination included in the communication log. The communication destination may be the monitoring target system 200 or may be the server and the like that the monitoring target system 200 includes. The content, as a specific example, is content displayed on a website or content of a file stored in a file server.

The content category deducing unit 122 learns a content category deducing model that is a learning model that deduces, using content data that indicates the content, a category of the content indicated in the content data, and deduces a category of content that the target device has using the content category deducing model learned and data that indicates the content that the target device has. The category that the content category deducing unit 122 deduced is also called a first deduced category. The first deduced category is a result of deducing the category of the content that the target device has. The content category deducing unit 122 does not have to learn the content category deducing model and may use a content category deducing model that a different device and the like generated. The content category deducing model, with the data that indicates the content as input, deduces a category corresponding to the data inputted. The content category deducing model is a learning model that learned a relationship between the data that indicates the content and the category, and may be an inference model based on machine learning, or may be a program and the like that adopts a system that is based on a rule such as a rule-based system and the like. The content category deducing model may be a model that infers a plurality of categories from one piece of content, and in a case where a plurality of categories are to be inferred, the content category deducing model may ascertain reliability and the like of each category. The content category deducing unit 122 may use any existing technology when learning the content category deducing model. A configuration of the content category deducing unit 122 may be a configuration that includes a category learning unit and a category verification unit.

The category comparing unit 123 compares a category of content that the communication destination currently has with a category of content that the communication destination had in the past by referring to the category that the content category deducing unit 122 deduced and the category DB 170. A configuration of the category comparing unit 123 may be a configuration that includes an old and new comparing unit. The category comparing unit 123 verifies whether or not the first deduced category and a category for comparison match. The category for comparison may be a result of deducing in the past the category of the content that the target device has using the content category deducing model and the data that indicates the content that the target device has.

It is considered that in a case where categories of content that servers have are same, communication logs of the servers are similar, and in a case where the categories of the content that the servers have differ from one another, the communication logs of the servers are not similar. The categories, as specific examples, are news, a search service, weather, or SNS (Social Networking Service). In a case where content of the content that the server has is tampered with by an attacker, it is considered that a change in the category of the content that the server has will be generated before and after being tampered with. Therefore, the consistency verification unit 120 deduces the category of the content that the communication destination has, and verifies whether or not there is consistency in the category deduced and a category of content that the communication destination has that is confirmed in a case where the communication destination is normal.

The information assignment unit 130 generates assignment information that is in accordance with a comparison result from the category comparing unit 123, and assigns the assignment information generated to the alert. The assignment information is information that is in accordance with whether or not the first deduced category and the category for comparison match. The alert is what indicates that there is an anomaly in communication of the monitoring target system 200. In a case where the communication log of the target device is deduced by the normal communication deducing model as not normal, the information assignment unit 130 assigns the assignment information generated to the alert generated.

The category DB 170 records, for each piece of communication destination information, data that indicates a set of the communication destination information and the category of the content that the communication destination has that the communication destination information indicates. The communication destination information is information that indicates the communication destination, and as a specific example, is a domain of the communication destination.

The monitoring target system 200 includes a log extracting device 210, and as a specific example, is an IT (Information Technology) system that includes a web server, an AD (Active Directory) server, a file server, a proxy server, a user terminal, and the like.

The log extracting device 210 extracts the communication log of the monitoring target system 200 and saves the communication log extracted.

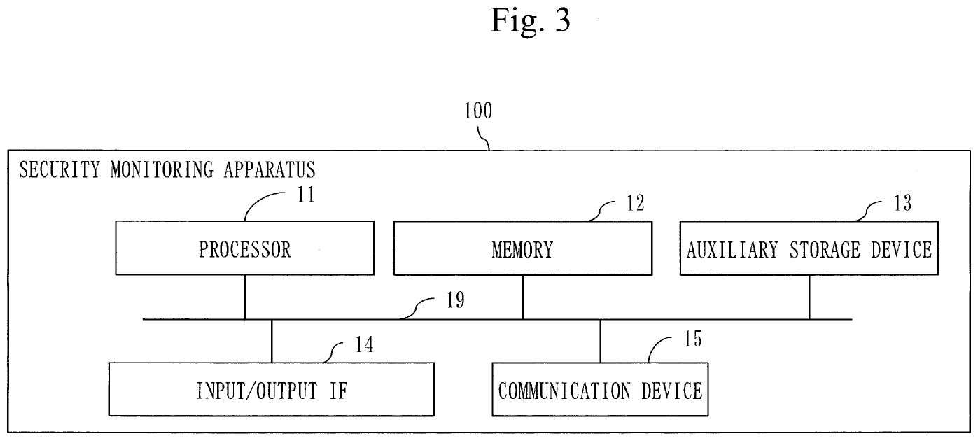

FIG. 3 illustrates an example of a hardware configuration of the security monitoring apparatus 100 according to the present embodiment. The security monitoring apparatus 100 consists of a computer. The security monitoring apparatus 100 may consist of a plurality of computers.

The security monitoring apparatus 100, as illustrated in the present diagram, is a computer that includes hardware such as a processor 11, a memory 12, an auxiliary storage device 13, an input/output IF (Interface) 14, a communication device 15, and the like. These pieces of hardware are suitably connected through a signal line 19.

The processor 11 is an IC (Integrated Circuit) that performs a calculation process, and controls hardware that the computer includes. The processor 11, as a specific example, is a CPU (Central Processing Unit), a DSP (Digital Signal Processor), or a GPU (Graphics Processing Unit).

The security monitoring apparatus 100 may include a plurality of processors that replace the processor 11. The plurality of processors share roles of the processor 11.

The memory 12 is typically a volatile storage device. The memory 12 is also called a main storage device or a main memory. The memory 12, as a specific example, is a RAM (Random Access Memory). Data stored in the memory 12 is saved in the auxiliary storage device 13 as necessary.

The auxiliary storage device 13 is typically a non-volatile storage device. The auxiliary storage device 13, as a specific example, is a ROM (Read Only Memory), an HDD (Hard Disk Drive), or a flash memory. Data stored in the auxiliary storage device 13 is loaded into the memory 12 as necessary.

The memory 12 and the auxiliary storage device 13 may be configured integrally.

The input/output IF 14 is a port to which an input device and an output device are connected. The input/output IF 14, as a specific example, is a USB (Universal Serial Bus) terminal. Input devices, as specific examples, are a keyboard and a mouse. The output device, as a specific example, is a display.

The communication device 15 is a receiver and a transmitter. The communication device 15, as a specific example, is a communication chip or an NIC (Network Interface Card).

Each unit of the security monitoring apparatus 100 may suitably use the input/output IF 14 and the communication device 15 when communicating with a different device and the like.

The auxiliary storage device 13 has stored a security monitoring program. The security monitoring program is a program that causes a computer to enable functions of each unit that the security monitoring apparatus 100 includes. The security monitoring program is loaded into the memory 12, and executed by the processor 11. The functions of each unit that the security monitoring apparatus 100 includes are enabled by software.

Data used when executing the security monitoring program, data obtained by executing the security monitoring program, and the like are suitably stored in a storage device. Each unit of the security monitoring apparatus 100 suitably utilizes the storage device. The storage device, as a specific example, consists of at least one of the memory 12, the auxiliary storage device 13, a register in the processor 11, and a cache memory in the processor 11. There is a case where data and information have an equal meaning. The storage device may be a device that is independent of the computer.

Functions of the memory 12 and the auxiliary storage device 13 may be enabled by a different storage device.

The security monitoring program may be recorded in a computer-readable non-volatile recording medium. The non-volatile recording medium, as a specific example, is an optical disc or a flash memory. The security monitoring program may be provided as a program product.

A hardware configuration of the log extracting device 210 is a same as the hardware configuration of the security monitoring apparatus 100.

Description of Operation

An operation procedure of the security monitoring apparatus 100 is equivalent to a security monitoring method. A program that enables operation of the security monitoring apparatus 100 is equivalent to the security monitoring program.

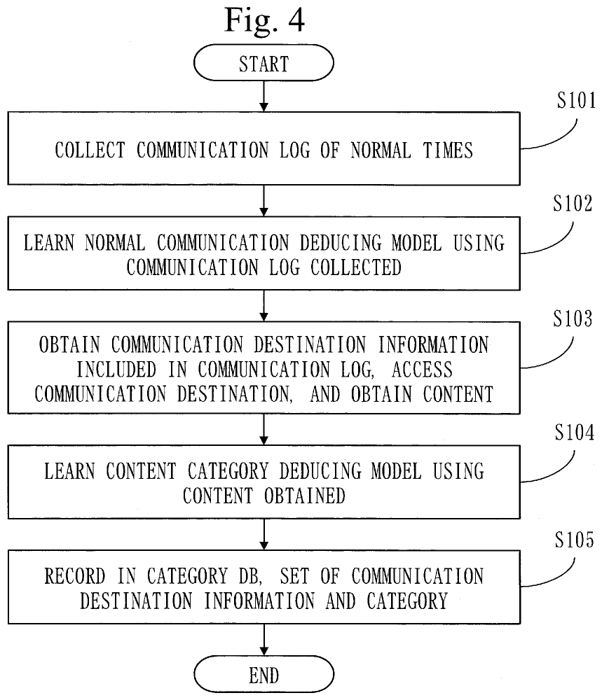

FIG. 4 is a flowchart illustrating an example of operation of the security monitoring apparatus 100 at a time of learning. The operation of the security monitoring apparatus 100 at the time of learning will be described by referring to the present diagram.

(Step S101)

In a case where the monitoring target system 200 is normal, the log extracting device 210 collects a communication log of the monitoring target system 200.

(Step S102)

The communication anomaly detection unit 110 obtains the communication log that the log extracting device 210 collected, and learns the normal communication deducing model using the communication log obtained. The communication anomaly detection unit 110 may learn the normal communication deducing model using a communication log of the monitoring target system 200 in a case where the monitoring target system 200 is not normal.

(Step S103)

The content obtaining unit 121 obtains communication destination information that the communication log indicates, accesses using the communication destination information obtained, a communication destination that the communication destination information indicates, and obtains content that the communication destination has.

(Step S104)

The content category deducing unit 122 learns the content category deducing model using the content obtained. Data that indicates a category of the content obtained may be given as training data when the content category deducing unit 122 learns the content category deducing model.

(Step S105)

The content category deducing unit 122 obtains the data that indicates the content that the communication destination has, and deduces the category of the content that the communication destination has indicated in the communication destination information obtained in step S103 using the data obtained and the content category deducing model. After that, the content category deducing unit 122 records in the category DB 170, data that indicates a set of the communication destination information and the category deduced.

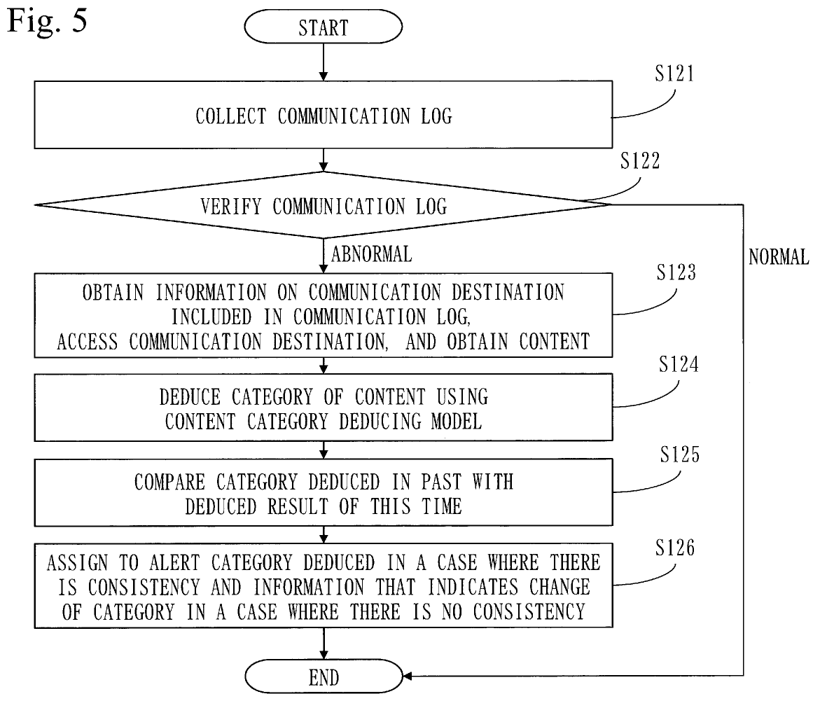

FIG. 5 is a flowchart illustrating an example of operation of the security monitoring apparatus 100 at a time of detection. The operation of the security monitoring apparatus 100 at the time of detection will be described by referring to the present diagram.

(Step S121)

The log extracting device 210 collects a communication log of the monitoring target system 200.

(Step S122)

The communication anomaly detection unit 110 obtains the communication log that the log extracting device 210 collected, and verifies whether or not the communication log obtained is normal using the normal communication deducing model and the communication log obtained. At this time, the communication anomaly detection unit 110 may confirm whether or not an alert is outputted from the normal communication deducing model.

In a case where the communication log is verified as normal, the security monitoring apparatus 100 ends the processes of the present flowchart. In other cases, the security monitoring apparatus 100 generates an alert and proceeds to step S123.

(Step S123)

The content obtaining unit 121 obtains communication destination information that the communication log indicates, accesses using the communication destination information obtained, a communication destination that the communication destination information indicates, and obtains data that indicates content that the communication destination has.

(Step S124)

The content category deducing unit 122 deduces a category of the content that the communication destination has using the content category deducing model and data that indicates content obtained.

(Step S125)

The category comparing unit 123 verifies whether or not there is consistency in a category of the communication destination.

Specifically, first, the category comparing unit 123 confirms a category of the past of the content of the communication destination that the communication destination information obtained in step S123 indicates by referring to the category DB 170. Next, the category comparing unit 123 verifies whether or not there is consistency between the category confirmed by referring to the category DB 170 and the category deduced in step S124.

In a case where the category DB 170 does not have recorded data that indicates the category of the past of the content of the communication destination that the communication destination information indicates, the category comparing unit 123 may skip the process of the present step, and may record in the category DB 170, data that indicates a set of the communication destination information obtained in step S123 and the category deduced in S124.

(Step S126)

In a case where there is consistency in the category of the communication destination, the information assignment unit 130 assigns assignment information that indicates the category deduced in step S124 to an alert. In other cases, the information assignment unit 130 assigns to the alert, as assignment information that indicates a change of category, information that indicates each of a category of the past of the communication destination and the category deduced in step S124.

In a case where, the category DB 170 does not have recorded the data that indicates the category of the past of the content of the communication destination that the communication destination information indicates, the information assignment unit 130 may assign assignment information to that effect to the alert.

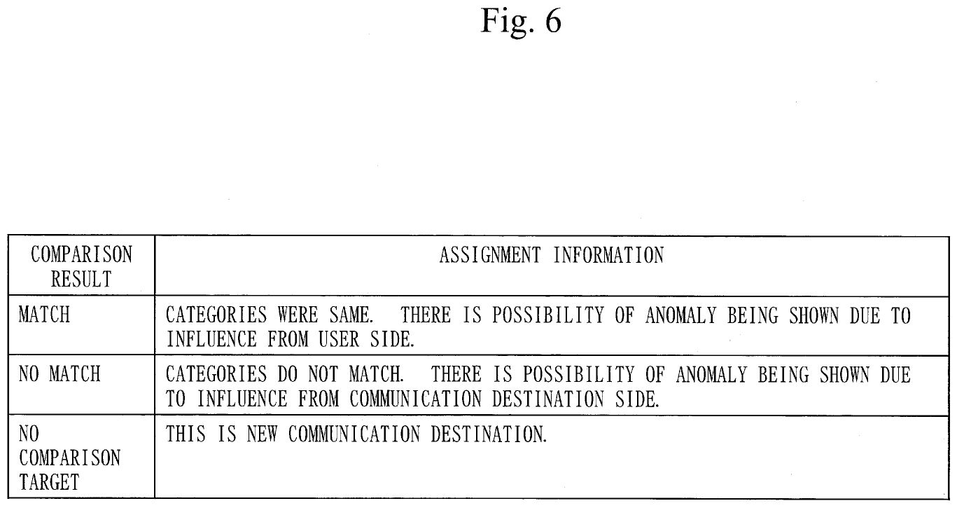

FIG. 6 illustrates a specific example of the assignment information that the information assignment unit 130 assigns. In FIG. 6, a “comparison result” column indicates results of comparison that the category comparing unit 123 drew. “No comparison target” corresponds to a case where the category DB 170 does not have recorded the data that indicates the category of the past of the content of the communication destination that the communication destination information indicates. An “assignment information” column indicates the assignment information that the information assignment unit 130 generates.

The security monitoring apparatus 100 suitably notifies an operator and the like of the alert.

Description of Effect of Embodiment 1

As described above, according to the present embodiment, the security monitoring apparatus 100 confirms whether or not the category of the content that the communication destination has changed from the past in a case where there is an anomaly in the communication log of the monitoring target system 200, and outputs the information that indicates the result of the confirmed. The information outputted is useful when an operator and the like of the monitoring target system 200 determines which of a user side and a communication destination side is considered to be a cause of the anomaly relating to communication. Consequently, according to the present embodiment, it will be easier for the operator and the like to understand, based on the result outputted, whether the cause of the anomaly in the communication log is on the user side or on the communication destination side and to deal with the anomaly in the communication log. Here the user side means a terminal and the like that accesses the communication destination. The anomaly in the communication log arising from the user side, as a specific example, is generated by a communication log different from usual being produced by an internal crime, an attacker, or malware, or produced by a communication log different from usual being produced by a cause that happened by coincidence. The anomaly arising from the communication destination side, as a specific example, is generated by a malicious content change such as a takeover, tampering, or the like, or generated by a communication log different from usual being produced by a proper content change. Here, there is a possibility that a feature of the communication log that differ from the time of learning appearing and the communication log being determined as an anomaly by mistake in a case where activity of a user with respect to a transmission destination changed by the proper content change in the transmission destination. Whether or not the content of the transmission destination has been changed cannot be understood from only a feature collected from the communication log, but according to the present embodiment, the operator and the like can understand relatively easily the change in the content and the like by outputting a result of comparing a current category of the content of the transmission destination with a category in the past of the content of the transmission destination.

According to the present embodiment, since action can be taken on an anomaly relating to communication of a communication destination that is not registered as a malicious URL or the like, and furthermore, only the learning model, the category, the domain, and the like are to be managed, an amount of models to be managed and an amount of data for comparison can be relatively small.

Other Configurations

### <Variation 1>

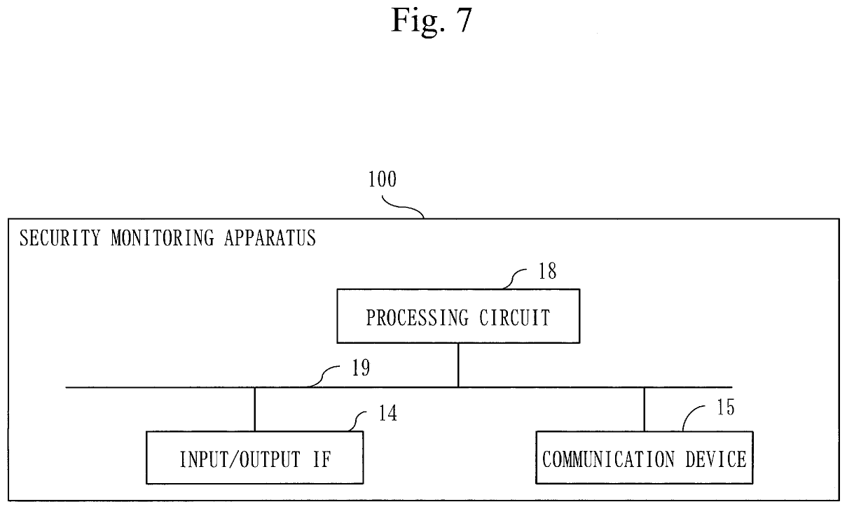

FIG. 7 illustrates an example of a hardware configuration of a security monitoring apparatus 100 according to the present variation.

The security monitoring apparatus 100 includes a processing circuit 18 instead of the processor 11, the processor 11 and the memory 12, the processor 11 and the auxiliary storage device 13, or the processor 11, the memory 12, and the auxiliary storage device 13.

The processing circuit 18 is hardware that enables at least a part of each unit that the security monitoring apparatus 100 includes.

The processing circuit 18 may be dedicated hardware and may be a processor that executes a program stored in the memory 12.

In a case where the processing circuit 18 is dedicated hardware, the processing circuit 18, as a specific example, is a single circuit, a composite circuit, a programmed processor, a parallel programmed processor, an ASIC (Application Specific Integrated Circuit), an FPGA (Field Programmable Gate Array), or a combination of these.

The security monitoring apparatus 100 may include a plurality of processing circuits that replace the processing circuit 18. The plurality of processing circuits share roles of the processing circuit 18.

In the security monitoring apparatus 100, a part of functions may be enabled by dedicated hardware and the rest of the functions may be enabled by software or firmware.

The processing circuit 18, as a specific example, is enabled by hardware, software, firmware, or a combination of these.

The processor 11, the memory 12, the auxiliary storage device 13, and the processing circuit 18 are generically called “processing circuitry”. That is, functions of each functional element of the security monitoring apparatus 100 are enabled by the processing circuitry.

As for the security monitoring apparatus 100 according to other embodiments, the security monitoring apparatus 100 may be in a same configuration as the configuration in the present variation. A configuration of the log extracting device 210 may be in a same configuration as the configuration of the present variation.

### Embodiment 2

Points different from the embodiment mentioned above will mainly be described below by referring to the drawings.

The present embodiment is based on an assumption that basically, when categories of content that a plurality of communication destinations have are same, a communication log of each of the plurality of communication destinations is similar to each other.

Description of Configuration

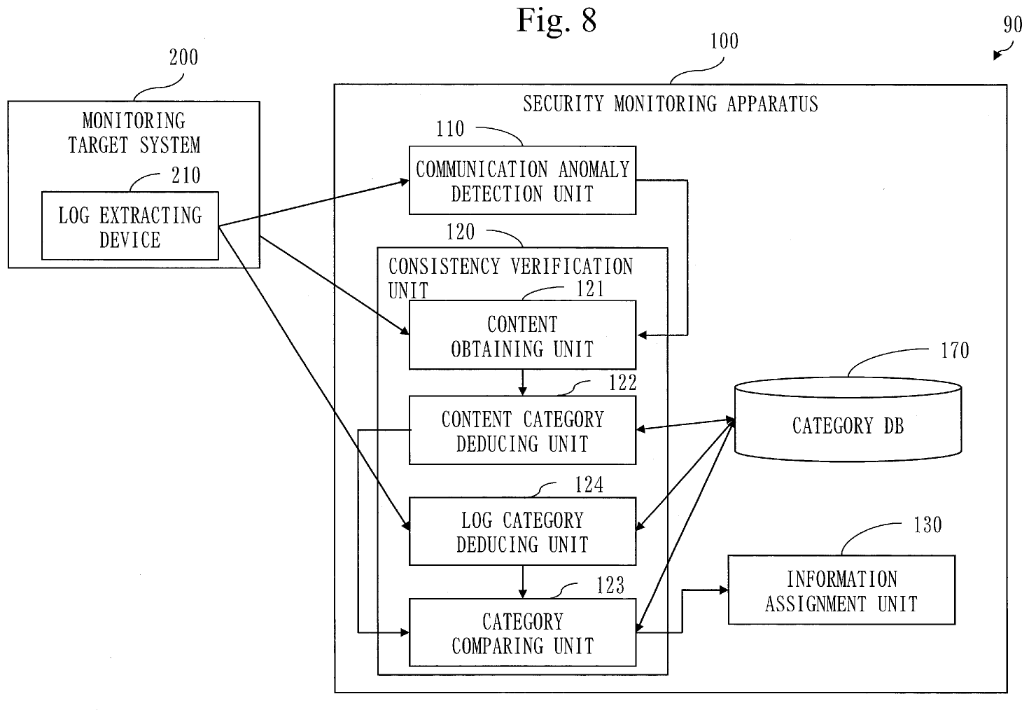

FIG. 8 illustrates an example of a configuration of a security monitoring system 90 according to the present embodiment.

A security monitoring apparatus 100 according to the present embodiment further includes a log category deducing unit 124 compared with the security monitoring apparatus 100 according to Embodiment 1.

The log category deducing unit 124 learns, using the communication log and data that indicates a category of content corresponding to the communication log, a log category deducing model that is a learning model that deduces, using the communication log of the content device that is a device having content, the content that the content device has, and deduces, using the log category deducing model learned and the communication log of the target device, the category of the content that the target device has. The log category deducing model is a model that deduces with the communication log or the feature of the communication log as input, the category of the content corresponding to the communication log. The content corresponding to the communication log is content that a device that executed communication that the communication log indicates has. The log category deducing model is a learning model that learned a relationship between the communication log of the device having the content and the category, and may be an inference model based on machine learning, or may be a program and the like that adopts a system that is based on a rule such as a rule-based system and the like. The log category deducing model may be a model that infers a plurality of categories from one communication log, and in a case where a plurality of categories are to be inferred, the log category deducing model may ascertain reliability and the like of each category. The category that the log category deducing unit 124 deduced is also called a second deduced category. The second deduced category is a result of deducing the category of the content that the target device has. The log category deducing unit 124 creates the log category deducing model without using the communication destination information in a way that the log category deducing model will not be a model dependent on information on the communication destination information. The log category deducing unit 124 does not have to learn the log category deducing model and may use a log category deducing model that a different device and the like generated. A configuration of the log category deducing unit 124 may be a configuration that includes a category learning unit and a category verification unit.

The security monitoring apparatus 100 or the monitoring target system 200 suitably saves the communication log of the monitoring target system 200 to learn the log category deducing model.

A category comparing unit 123 according to the present embodiment verifies whether or not the first deduced category, the second deduced category, and the category for comparison match. A configuration of the category comparing unit 123 may be a configuration that includes the old and new comparing unit and a log comparing unit.

An information assignment unit 130 according to the present embodiment generates assignment information that is in accordance with a match situation between the first deduced category, the second deduced category, and the category for comparison.

Description of Operation

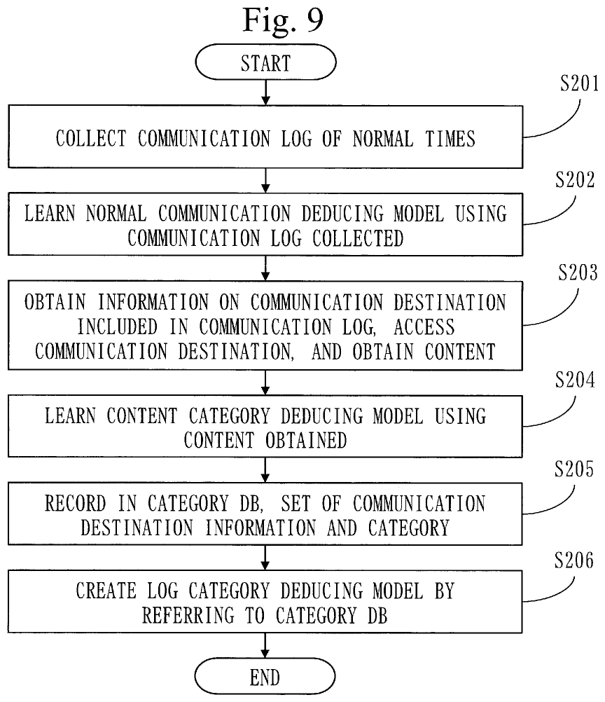

FIG. 9 is a flowchart illustrating an example of operation of the security monitoring apparatus 100 at a time of learning. The operation of the security monitoring apparatus 100 at the time of learning will be described by referring to the present diagram.

(Step S201)

The present step is a same as step S101.

(Step S202)

The present step is a same as step S102.

(Step S203)

The present step is a same as step S103.

(Step S204)

The present step is a same as step S104.

(Step S205)

The present step is a same as step S105.

(Step S206)

The log category deducing unit 124 creates the log category deducing model using each piece of data that indicates the category that the category DB 170 has recorded and the communication log corresponding to each piece of data that indicates the category.

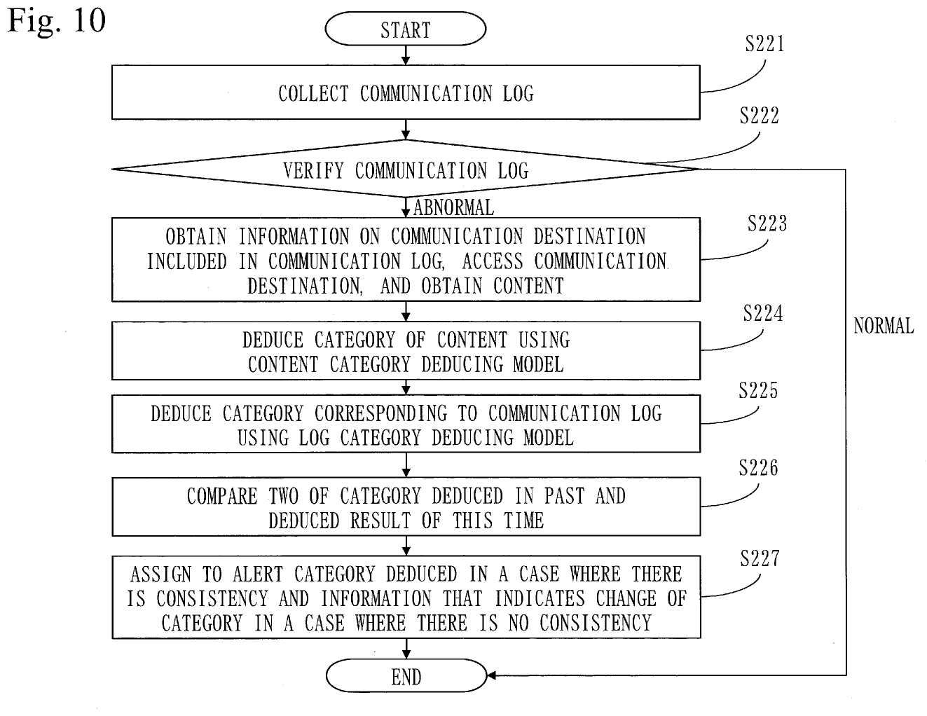

FIG. 10 is a flowchart illustrating an example of operation of the security monitoring apparatus 100 at a time of detection. The operation of the security monitoring apparatus 100 at the time of detection will be described by referring to the present diagram.

(Step S221)

The present step is a same as step S121.

(Step S222)

The present step is a same as step S122.

(Step S223)

The present step is a same as step S123.

(Step S224)

The present step is a same as step S124.

(Step S225)

The log category deducing unit 124 deduces the category of the content that the communication destination has using the log category deducing model and the communication log obtained in step S222.

(Step S226)

The category comparing unit 123 executes a same process as the process of step S125. The category comparing unit 123 verifies whether or not there is consistency between the category confirmed by referring to the category DB 170 and the category deduced in step S225.

(Step S227)

The present step is a same as step S126. The information assignment unit 130, however, executes a process for a case where there is consistency in a category of the communication destination only in a case where all three categories used in step S226 are same.

In a case where there is no consistency in a category of the communication destination, the information assignment unit 130 assigns to the alert assignment information that indicates each of the category of the past of the communication destination, the category deduced in step S224, and the category deduced in step S225.

Description of Effect of Embodiment 2

As described above, according to the present embodiment, since the category of the content is deduced using the log category deducing model in addition to the content category deducing model, deducing accuracy of the category can be increased.

### Embodiment 3

Points different from the embodiments mentioned above will mainly be described below by referring to the drawings.

Description of Configuration

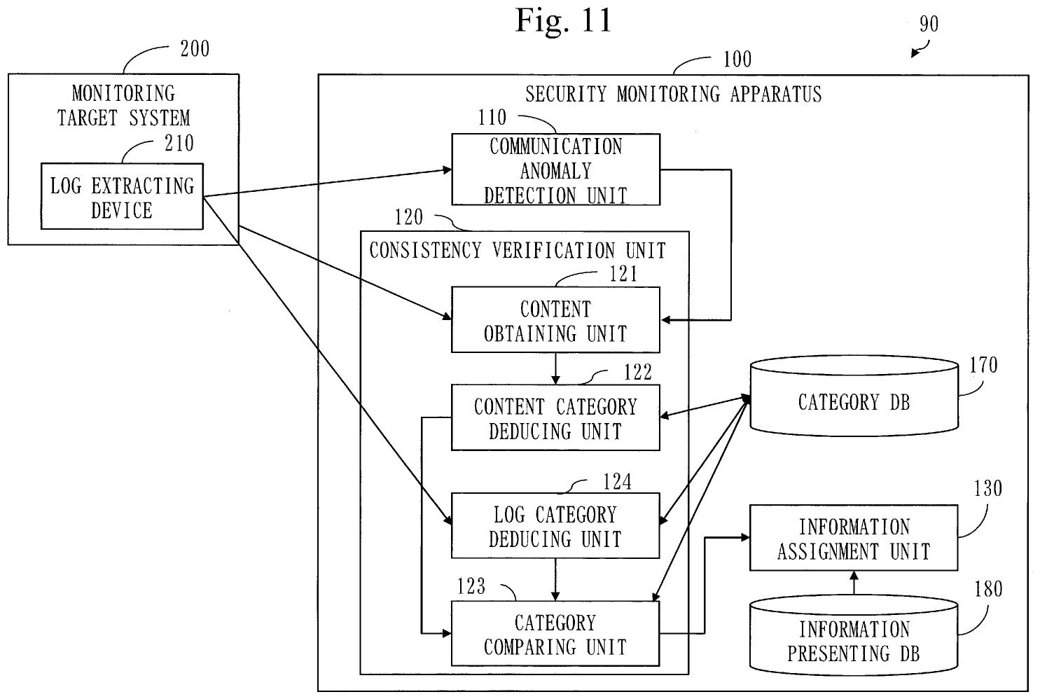

FIG. 11 illustrates an example of a configuration of a security monitoring system 90 according to the present embodiment.

A security monitoring apparatus 100 according to the present embodiment further includes an information presenting DB 180 compared with the security monitoring apparatus 100 according to Embodiment 2.

The information presenting DB 180 has recorded the assignment information that the information assignment unit 130 assigns and an information presenting rule that is a rule for the information assignment unit 130 to assign the assignment information.

The information assignment unit 130 according to the present embodiment generates the assignment information by following the information presenting rule, and assigns the assignment information to the alert in accordance with the information presenting DB 180.

Description of Operation

Operation of the security monitoring apparatus 100 according to the present embodiment is basically a same as the operation of the security monitoring apparatus 100 according to Embodiment 2. Distinctive operation of the security monitoring apparatus 100 according to the present embodiment will mainly be described.

(Step 6227)

The information assignment unit 130 assigns the assignment information to the alert in accordance with the information presenting DB 180.

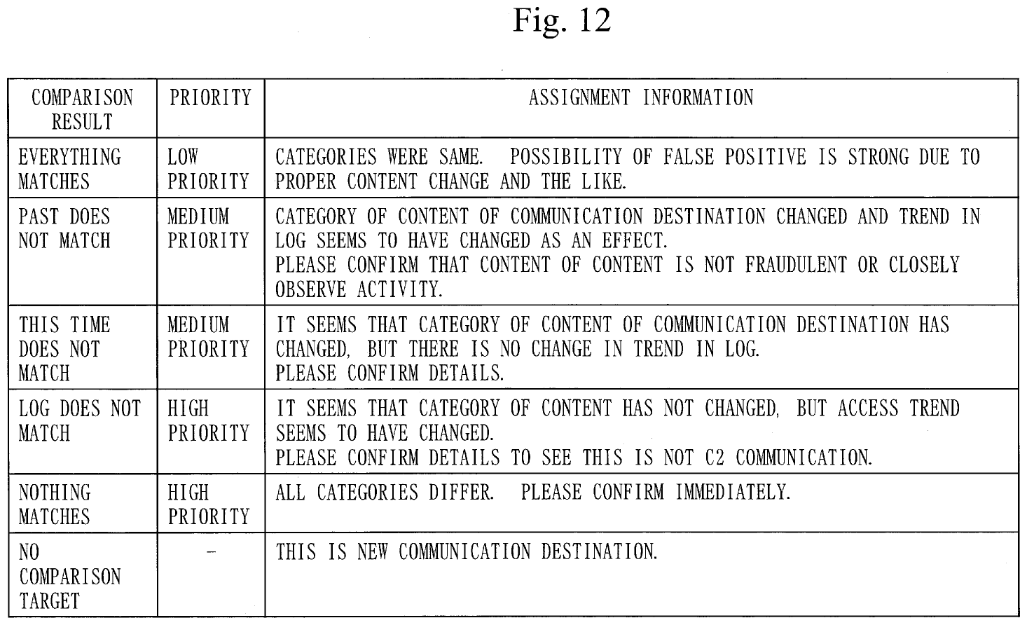

FIG. 12 illustrates a specific example of the assignment information that the information assignment unit 130 assigns. In the present diagram, a “priority” column illustrates a degree to which the monitoring target system 200 should be confirmed, that is, a possibility of an anomaly being produced in the monitoring target system 200.

In FIG. 12, “everything matches” indicates that every one of the three categories matches. In a case where “everything matches”, the information assignment unit 130 assigns assignment information that indicates a possibility of an anomaly detection in the communication log being a false positive is strong to the alert.

“Past does not match” indicates that a category of this time and a category of a log match, and that the category of this time and a category of the past do not match. Here, the category of this time is a category deduced using the content category deducing model, the category of the past is a category that the category DB 170 has recorded, and the category of the log is a category deduced using the log category deducing model. In a case where “past does not match”, the information assignment unit 130 assigns assignment information that indicates that there is a possibility of a trend in a communication log of the communication destination changed because the category of the content that the communication destination has changed to the alert.

“This time does not match” indicates that the category of the past and the category of the log match, and that the category of this time and the category of the log do not match. In a case where “this time does not match”, the information assignment unit 130 assigns assignment information that indicates that the category of the content that the communication destination has can be considered to have changed, but there is no change in the trend in the communication log to the alert.

“Log does not match” indicates that the category of the past and the category of this time match, and that the category of this time the category of the log do not match. In a case where “log does not match”, the information assignment unit 130 assigns assignment information that indicates that the category of the content has not changed, but an access trend in the communication destination changed to the alert.

“Nothing matches” indicates that the three categories differ from one another. In a case where “nothing matches”, the information assignment unit 130 assigns assignment information that indicates that a possibility of an anomaly being produced in the communication destination being strong to the alert.

Description of Effect of Embodiment 3

As described above, according to the present embodiment, since the information assignment unit 130 assigns the information in accordance with the information presenting DB 180, it will be easier for the user to understand details of the anomaly in the communication log.

### Embodiment 4

Points different from the embodiments mentioned above will mainly be described below by referring to the drawings.

Description of Configuration

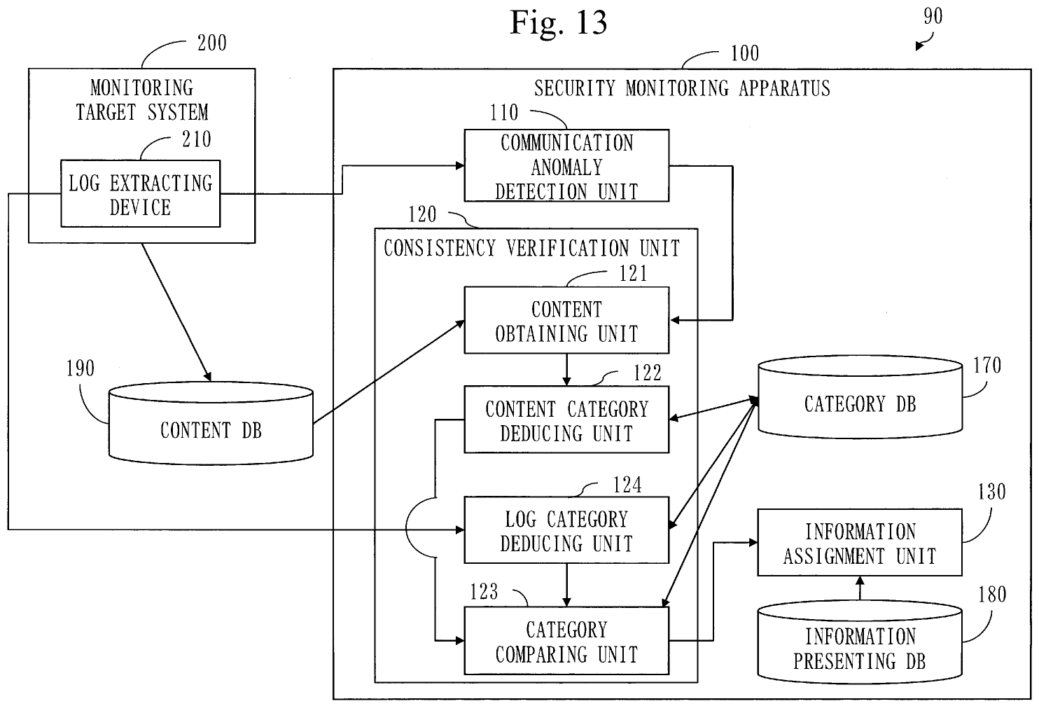

FIG. 13 illustrates an example of a configuration of a security monitoring system 90 according to the present embodiment.

The security monitoring system 90 according to the present embodiment further includes a content DB 190 compared with the security monitoring system 90 according to Embodiment 3. The content DB 190 may be configured integrally with the security monitoring apparatus 100.

FIG. 13 illustrates a configuration of the present embodiment based on Embodiment 3, but the present embodiment may be based on Embodiment 1 or 2.

The content DB 190 records data that indicates content that the monitoring target system 200 has. The content DB 190 suitably obtains the data that indicates the content from the monitoring target system 200 and records the data obtained. The content DB 190 may record the data that indicates the content by linking the data that indicates the content with data that indicates a point in time when the data that indicates the content is obtained.

A content category deducing unit 122 according to the present embodiment uses data obtained from a database in which the data that indicates the content that the target device has is stored.

Description of Operation

Operation of the security monitoring apparatus 100 according to the present embodiment is basically a same as the operation of the security monitoring apparatus 100 according to the embodiments mentioned above.

The content obtaining unit 121, however, obtains the data that the content DB 190 has recorded instead of obtaining the data that indicates the content from the monitoring target system 200.

Description of Effect of Embodiment 4

According to the present embodiment, the content obtaining unit 121 obtains instead of the monitoring target system 200, the data that indicates the content from the content DB 190. Consequently, according to the present embodiment, the content obtaining unit 121 can appropriately obtain content of a website and the like that have content authentication functions.

### OTHER EMBODIMENTS

A free combination of each embodiment mentioned above, or a variation of any element of each embodiment, or omitting of any element in each embodiment is possible.

The embodiments are not to be limited to the embodiments indicated in Embodiment 1 to 4, and various changes are possible to be made as necessary. Procedures described using the flowcharts and the like may suitably be changed.

### REFERENCE SIGNS LIST

11: processor; 12: memory; 13: auxiliary storage device; 14: input/output IF; 15: communication device; 18: processing circuit; 19: signal line; 90: security monitoring system; 100: security monitoring apparatus; 110: communication anomaly detection unit; 120: consistency verification unit; 121: content obtaining unit; 122: content category deducing unit; 123: category comparing unit; 124: log category deducing unit; 130: information assignment unit; 170: category DB; 180: information presenting DB; 190: content DB; 200: monitoring target system; 210: log extracting device.

1. A security monitoring apparatus comprising:
processing circuitry to:
deduce a first deduced category that is a result of deducing a category of content that a target device that a monitoring target system includes has, using a content category deducing model that is a learning model that deduces using content data that indicates content, a category of content indicated in the content data, and data that indicates content that the target device has,
verify whether or not the first deduced category and a category for comparison match, and
generate assignment information that is in accordance with whether or not the first deduced category and the category for comparison match.

2. The security monitoring apparatus according to claim 1, wherein
the category for comparison is a result of deducing in the past category of content that the target device has using the content category deducing model and data that indicates content that the target device has.

3. The security monitoring apparatus according to claim 1, wherein
the content category deducing model is a learning model that learned a relationship between data that indicates content and a category.

4. The security monitoring apparatus according to claim 1, wherein
the processing circuitry
deduces a second deduced category that is a result of deducing a category of content that the target device has, using a log category deducing model that is a learning model that deduces using a communication log of a content device that is a device having content, a category of content that the content device has, and a communication log of the target device,
verifies whether or not the first deduced category, the second deduced category, and the category for comparison match, and
generates assignment information that is in accordance with a match situation between the first deduced category, the second deduced category, and the category for comparison.

5. The security monitoring apparatus according to claim 4, wherein
the log category deducing model is a learning model that learned a relationship between a communication log of a device having content and a category.

6. The security monitoring apparatus according to claim 1, wherein
the processing circuitry uses data obtained from a database in which data that indicates content that the target device has is stored.

7. The security monitoring apparatus according to claim 1, wherein
the processing circuitry generates the assignment information by following an information presenting rule.

8. The security monitoring apparatus according to claim 1, wherein
the processing circuitry
deduces, using a normal communication deducing model that is a learning model that deduces using a communication log of a content device that is a device having content, whether or not a communication log of the content device is an anomaly, and a communication log of the target device, whether or not a communication log of the target device is normal, and generates an alert in a case where a communication log of the target device is deduced as not normal, and
in a case where a communication log of the target device is deduced by the normal communication deducing model as not normal, assigns assignment information generated to an alert generated.

9. A security monitoring method comprising:
deducing a first deduced category that is a result of deducing a category of content that a target device that a monitoring target system includes has, using a content category deducing model that is a learning model that deduces using content data that indicates content, a category of content indicated in the content data, and data that indicates content that the target device has, by a computer;
verifying whether or not the first deduced category and a category for comparison match, by the computer; and
generating assignment information that is in accordance with whether or not the first deduced category and the category for comparison match, by the computer.

10. A non-transitory computer readable medium storing a security monitoring program that causes a security monitoring apparatus that is a computer to execute:
a content category deducing process to deduce a first deduced category that is a result of deducing a category of content that a target device that a monitoring target system includes has, using a content category deducing model that is a learning model that deduces using content data that indicates content, a category of content indicated in the content data, and data that indicates content that the target device has;
a category comparing process to verify whether or not the first deduced category and a category for comparison match; and
an information assignment process to generate assignment information that is in accordance with whether or not the first deduced category and the category for comparison match.
